(19) United States
(12) Patent Application Publication
(10) Pub. No.: US 2013/0313978 A1
(43) Pub. Date: Nov. 28, 2013

(54) LED FLOOD LIGHT INCLUDING THERMOSENSITIVE AND PHOTOSENSITIVE SENSORS

(71) Applicants: Marc Howard Fields, Kingwood, TX (US); Li Dong Xie, Ningbo (CN)

(72) Inventors: Marc Howard Fields, Kingwood, TX (US); Li Dong Xie, Ningbo (CN)

(21) Appl. No.: 13/869,604

(22) Filed: Apr. 24, 2013

(30) Foreign Application Priority Data
May 23, 2012 (CN) 201220241933.6

(51) Int. Cl. H05B 33/08

(52) U.S. Cl. CPC H05B 33/0854
USPC 315/155

(57) ABSTRACT

In accordance with various embodiments, there is provided a light-emitting diode lamp, which includes a body shell, and a light source assembly arranged in a cavity of the body shell. The light source assembly includes a light-emitting diode. The light-emitting diode lamp further includes a thermosensitive sensor, and a photosensitive sensor. The thermosensitive sensor and the photosensitive sensor are independently and automatically configured to detect, respectively, a presence of a person and ambient light near the light-emitting diode lamp.

### RELATED APPLICATION

This application claims the benefit of and priority to Chinese Patent Application No. 201220241933.6, filed on May 23, 2012, now Chinese Utility Model Patent No. CN202660299U, issued on Jan. 9, 2013, which is incorporated herein in its entirety.

### BACKGROUND 1. Field of the Invention

Embodiments of the invention generally relate to a lamp, and more particularly, to a light-emitting diode (LED) lamp including a thermosensitive sensor and a photosensitive sensor, which control an operation of the lamp in response to detection of the presence of a person or ambient light near the LED lamp.

2. Description of the Related Art

With the phasing out of incandescent light sources, LED light sources (or LED lamps) are increasingly being used because they provide numerous advantages over conventional light sources. LED lamps provide a long operational life, high luminance, energy conservation, and environmental protection when compared with conventional light sources. LED lamps are widely used for many applications, such as indoor lighting, automobile head- and tail-lights, street lighting, etc. Most LED lamps, however, require external switches to operate the LED lamps. In most cases, the external switches must be operated manually. With low operational intelligence, such LED lamps are inconvenient for applications in low light (e.g., ambient light) conditions. For example, conventional LED lamps are capable of sensing ambient light, and therefore can be turned on automatically in low ambient light conditions and turned off automatically in high ambient light conditions. Other conventional LED lamps are capable of automatically sensing the presence of a person near the LED lamp (i.e., the LED lamp is turned on automatically when a person gets close to the LED lamp and is turned off automatically when a person moves away from the LED lamp.

Conventional LED lamps lack, however, operational intelligence for controlling the LED lamp in scenarios involving the detection of the presence of a person and ambient light near the LED lamp. For example, conventional LED lamps are capable of detecting ambient light, and therefore will turn on automatically when luminance of the ambient light is lowered to a sensing threshold, regardless of whether there is a person getting close to the LED lamp or not. In this scenario, the conventional LED lamp is illuminating an area where no person is present, and therefore consumes unnecessary energy and creates unnecessary light pollution. In another example, conventional LED lamps are capable of detecting the presence of a person near the LED lamp (i.e., when the person moves close to the LED lamp, regardless of the luminance of ambient light in the area around the LED lamp). In one scenario, the conventional LED lamp illuminates an area when a person is detected near the LED lamp, where there is sufficient ambient light in the area, such that the user does not need the assistance of the LED lamp, and therefore consumes unnecessary energy and creates unnecessary light pollution.

### SUMMARY

Embodiments of the invention are generally directed to a lamp, and more particularly to a LED lamp including a thermosensitive sensor and a photosensitive sensor. The LED lamp, according to various embodiments of the invention, provides improved energy conservation and environmental protection over conventional LED lamps by incorporating the thermosensitive sensor and the photosensitive sensor to independently and automatically detect the presence of a person and ambient light near the LED lamp. Various embodiments provide a LED lamp, which includes a body shell and a LED assembly arranged in the body shell. In accordance with at least one embodiment, the body shell includes the thermosensitive sensor and the photosensitive sensor. In accordance with at least one embodiment, the thermosensitive sensor includes a thermosensitive housing and the photosensitive sensor includes a light-controlling housing.

In particular, in accordance with an embodiment of the invention, there is provided a LED lamp, which includes a body shell, and a light source assembly arranged in a cavity of the body shell. The light source assembly includes a LED. The LED lamp further includes a thermosensitive sensor, and a photosensitive sensor. The thermosensitive sensor and the photosensitive sensor are independently and automatically configured to detect, respectively, a presence of a person and ambient light near the LED lamp.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a schematic diagram of a LED lamp, in accordance with an embodiment of the invention.

FIG. 2 is a longitudinal sectional view of the LED lamp shown in FIG. 1, in accordance with an embodiment of the invention.

FIG. 3 is an exploded schematic diagram of the LED lamp shown in FIG. 1, in accordance with an embodiment of the invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. Prime notation, if used, indicates similar elements in alternative embodiments.

Embodiments of the invention provide a LED lamp that independently and automatically detects the presence of a person and ambient light near the LED lamp for controlling an operation of the LED lamp.

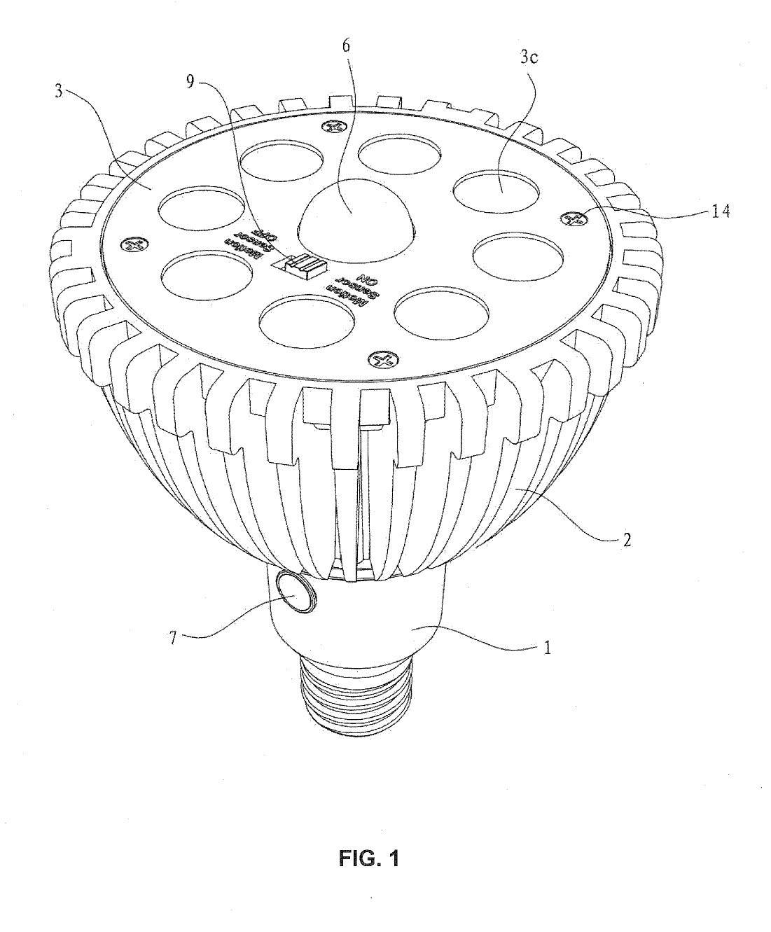

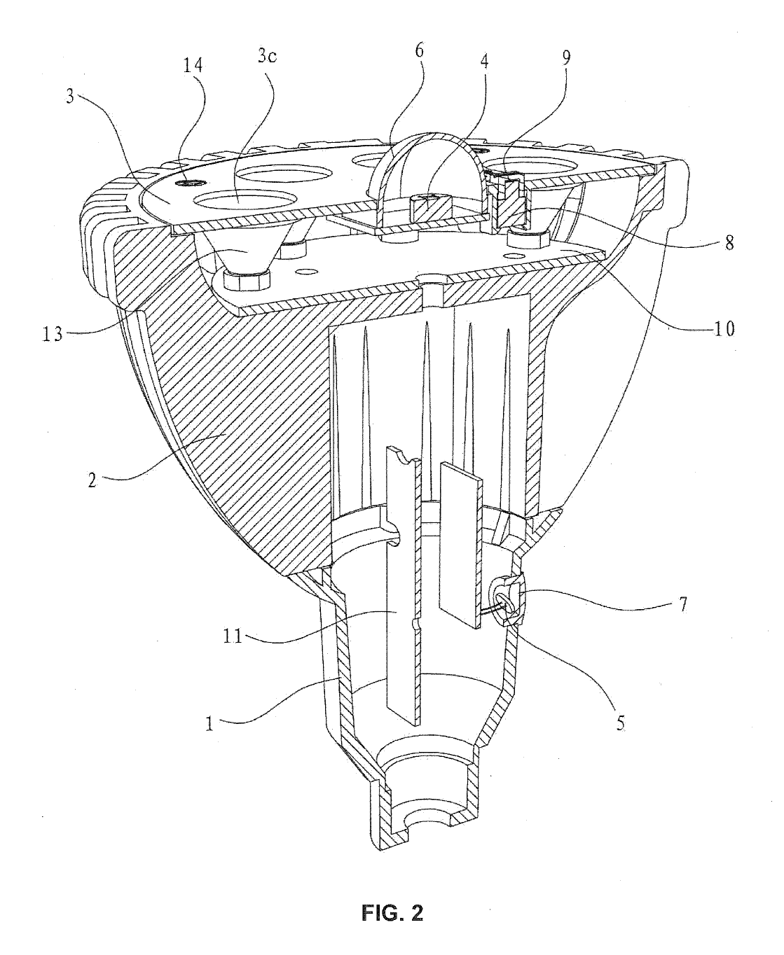

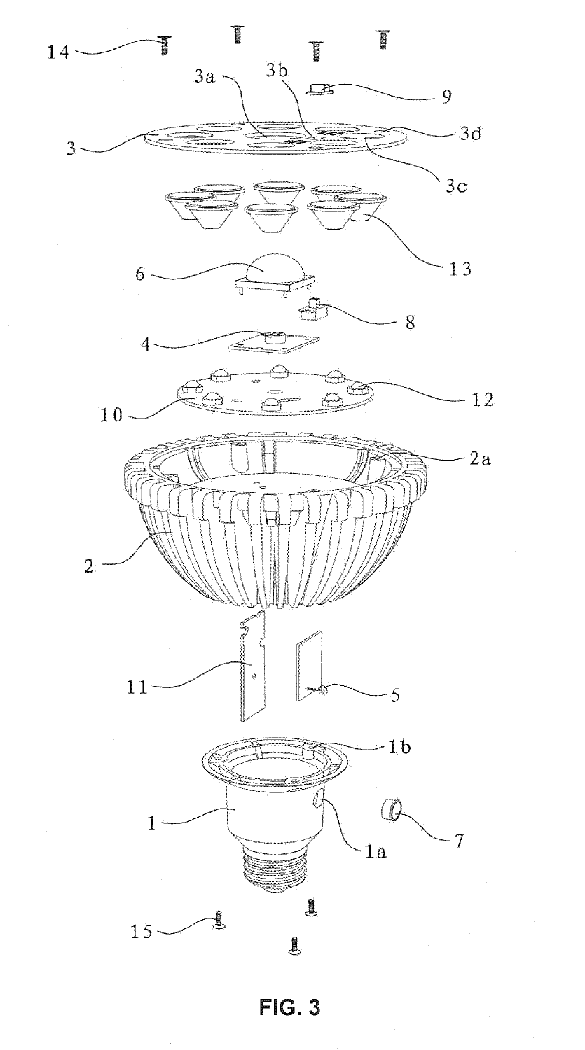

FIG. 1 is a schematic diagram of a LED lamp, in accordance with an embodiment of the invention. FIG. 2 is a longitudinal sectional view of the LED lamp shown in FIG. 1, in accordance with an embodiment of the invention. FIG. 3 is an exploded schematic diagram of the LED lamp shown in FIG. 1, in accordance with an embodiment of the invention. As shown in FIGS. 1-3, the LED lamp, according to various embodiments of the invention, includes a shell body and a LED assembly mounted in the shell body. The shell body includes a lamp holder 1, a lamp shade 2, and a cover plate 3 for the lamp shade 2. In accordance with at least one embodiment, the lamp shade 2 is configured in a bowl shape, as a non-limiting example, and interengaged with the lamp holder 1. One of ordinary skill in the relevant art would understand that the lamp shade 2 could be configured in other shapes, as long as the lamp holder 1 and the lamp shade 2 interengage with one another.

The cover plate 3 for the lamp shade 2 is mounted on a top surface of the lamp shade 2. As shown in FIG. 3, the lamp shade 2 includes a plurality of upper mounting poles 2a on an inner wall thereof, and the cover plate 3 for the lamp shade 2 includes a plurality of upper mounting holes 3d at locations corresponding to the plurality of upper mounting poles 2a in the lamp shade 2, when the lamp shade 2 and the cover plate 3 are interengaged. A plurality of upper fastening screws 14 are fixed in the upper mounting poles 2a through the upper mounting holes 3d to secure the cover plate 3 to the lamp shade 2.

As further shown in FIG. 3, the lamp holder 1, in accordance with at least one embodiment, includes a plurality of lower mounting holes 1b on a top surface thereof. The lamp shade 2 includes a plurality of lower mounting poles (not shown) at locations corresponding to the plurality of lower mounting holes 1b of the lamp holder 1, when the lamp holder 1 and the lamp shade 2 are interengaged. A plurality of lower fastening screws 15 are fixed in the lower mounting poles through the lower mounting holes 1b of the lamp holder 1. By fastening the upper and lower screws 14, 15, the lamp holder 1, the lamp shade 2, and the cover plate 3 of the lamp shade 2 are interengaged with one another to be a complete body shell.

As further shown in FIGS. 2 and 3, the LED assembly, according to various embodiments, includes a LED circuit board 10 and a LED driving board 11 for controlling the operation of the LED circuit board 10. In accordance with at least one embodiment, the LED circuit board 10 includes a plurality of LED bulbs 12 mounted on a top surface thereof. A transparent light shade 13, as shown in FIG. 2, is arranged over each LED bulb 12 to direct the light from the LED lamp. In particular, each transparent light shade 13 has a protruding lower surface, such that each transparent light shade 13 acts as a convex lens. The cover plate 3 for the lamp shade 2 further includes a plurality of light holes 3c, each light hole 3c corresponding to a respective transparent light shade 13. The transparent light shades 13 and the light holes 3c are oriented to disperse light emitted from the LED bulbs 12 of the body shell of the LED lamp.

Embodiments of the invention provide non-obvious advantages over conventional LED lamps. The LED lamp, according to various embodiments, independently and automatically detects the presence of a person and ambient light near the LED lamp for controlling an operation of the LED lamp. The presence of the person is detected by the thermosensitive sensor 4. In accordance with at least one embodiment, the thermosensitive sensor 4 is an infrared sensor, as a non-limiting example, and is located over the LED circuit board 10. The thermosensitive sensor 4 is covered by a heat-sensing housing 6. As shown in FIG. 3, the cover plate 3 for the lamp shade 2 includes a first sensing hole 3a, inside of which the heat-sensing housing 6 is mounted. In operation, the thermosensitive sensor 4 detects a heat profile of the person, when the person moves within a proximity of the LED lamp, and transfers a signal to the LED circuit board 10. In response to receiving the signal from the thermosensitive sensor 4, the LED circuit board 10 activates the LED bulbs 12 to illuminate the area around the LED lamp.

The presence of ambient light is detected by the photosensitive sensor 5. In accordance with at least one embodiment, the photosensitive sensor 5 is covered by a light-controlling housing 7. As shown in FIG. 3, the lamp holder 1 includes a second sensing hole 1a, inside of which the light-controlling housing 7 is mounted. In operation, the photosensitive sensor 5 detects the presence of ambient light within a proximity of the LED lamp, and transfers a signal to the LED circuit board 10. In response to receiving the signal from the photosensitive sensor 5, the LED circuit board 10 activates the LED bulbs 12 to illuminate the area around the LED lamp. In accordance with at least one embodiment, the photosensitive sensor 5 is adjustable to detect varying degrees of luminance of ambient light outside of the LED lamp.

In accordance with various embodiments, the sensitivity of the thermosensitive sensor 4 and the photosensitive sensor 5 can be adjusted to control a distance from the LED lamp at which these sensors detect the presence of a person or ambient light, respectively. As a result, the LED lamp provides operational intelligence for improving energy conservation and environmental protection over conventional LED lamps. As a non-limiting example, the operational intelligence of the LED lamp controls the LED bulbs 12 in an “ON” position, when a person is detected, by the thermosensitive sensor 4, near the LED lamp, and when the detected ambient light near the LED lamp is below a threshold level (i.e., when the area around the LED lamp turns dark).

As another non-limiting example, the operational intelligence of the LED lamp controls the LED bulbs 12 in an “OFF” position, when there is no person present near the LED lamp with low ambient light conditions (i.e., the thermosensitive sensor 4 does not detect the presence of a person near the LED lamp, and the photosensitive sensor 5 is able to identify low ambient light conditions, which do not require the LED lamp to illuminate). As another non-limiting example, the operational intelligence of the LED lamp controls the LED bulbs 12 in the “OFF” position, when there is a person present near the LED lamp with high ambient light conditions (i.e., the thermosensitive sensor 4 detects the presence of a person near the LED lamp, but the LED lamp is not operated because the photosensitive sensor 5 detects that the high ambient light conditions around the LED lamp do not require the LED lamp to illuminate).

Generally, various embodiments of the invention provide a LED lamp that automatically analyzes the received signals from the thermosensitive sensor 4 and the photosensitive sensor 5, and automatically processes the signals to ensure that the LED lamp will not be turned “ON” when there is no person present or when the ambient light is sufficient.

As further shown in FIGS. 1-3, the LED lamp includes a toggle switch 8 for controlling the LED assembly. In accordance with at least one embodiment, the toggle switch 8 is mounted in the lamp shade 2 to enable manual control of the LED lamp, and includes a push button 9. The push button 9 is mounted in a through hole 3b on the cover plate 3 for the lamp shade 2, and switches the toggle switch 8 to the “ON” position or the “OFF” position. In operation, the thermosensitive sensor 4 is activated when the toggle switch 8 is set to the “ON” position, and is deactivated when the toggle switch is set to the “OFF” position. Thus, when the toggle switch 8 is in the “OFF” position, only the photosensitive sensor 5 is activated, which means that the LED lamp functions similarly to a conventional optically-controlled lamp that is activated in low luminance (e.g., at night) and deactivated in high luminance (e.g., during the daytime). When the toggle switch 8 is in the “ON” position, the thermosensitive sensor 4 is activated, and thus will detect the presence of a person near the LED lamp. In accordance with at least one embodiment, the LED lamp will turn “OFF” after a period of time lapses when the person is no longer detected. In the “ON” position, although the thermosensitive sensor 4 would detect the presence of a person near the LED lamp, the LED lamp would remain “OFF” because the photosensitive sensor 5 would detect that there is sufficient light near the LED lamp. Accordingly, various embodiments of the invention provide a LED lamp, which provides the operational intelligence for improving energy conservation and environmental protection over conventional LED lamps.

Embodiments of the present invention may suitably comprise, consist or consist essentially of the elements disclosed and may be practiced in the absence of an element not disclosed. For example, it can be recognized by those skilled in the art that certain steps can be combined into a single step.

Unless defined otherwise, all technical and scientific terms used have the same meaning as commonly understood by one of ordinary skill in the art to which this invention belongs.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

As used herein, terms such as “first” and “second” are arbitrarily assigned and are merely intended to differentiate between two or more components of an apparatus. It is to be understood that the words “first” and “second” serve no other purpose and are not part of the name or description of the component, nor do they necessarily define a relative location or position of the component. Furthermore, it is to be understood that the mere use of the term “first” and “second” does not require that there be any “third” component, although that possibility is contemplated under the scope of the embodiments of the present invention.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A light-emitting diode lamp, comprising:
a body shell;
a light source assembly arranged in a cavity of the body shell, the light source assembly comprising a light-emitting diode;
a thermosensitive sensor; and
a photosensitive sensor,
wherein the thermosensitive sensor and the photosensitive sensor are independently and automatically configured to detect, respectively, a presence of a person and ambient light near the light-emitting diode lamp.

2. The light-emitting diode lamp of claim 1, wherein the light source assembly is configured to activate the light-emitting diode to an ON position, when the thermosensitive sensor detects the presence of the person and the photosensitive sensor detects that the ambient light near the light-emitting diode lamp is below a threshold level.

3. The light-emitting diode lamp of claim 1, wherein the light source assembly is configured to activate the light-emitting diode to an OFF position, when the presence of the person is not detected by the thermosensitive sensor and when the photosensitive sensor detects that the ambient light near the light-emitting diode lamp is above a threshold level.

4. The light-emitting diode lamp of claim 1, wherein the light source assembly is configured to activate the light-emitting diode to an OFF position, when the thermosensitive sensor detects the presence of the person and the photosensitive sensor detects that the ambient light near the light-emitting diode lamp is above a threshold level, or when the presence of the person is not detected by the thermosensitive sensor and the photosensitive sensor detects that the ambient light near the light-emitting diode lamp is below a threshold level.

5. The light-emitting diode lamp of claim 1, wherein the body shell comprises a lamp holder, a lamp shade, and a cover plate of the lamp shade, wherein the cover plate comprises a heat-sending housing configured to cover thermosensitive sensor, and wherein the lamp holder comprises a light-controlling housing configured to cover the photosensitive sensor.

6. The light-emitting diode lamp of claim 1, wherein the light source assembly comprises a LED circuit board and a LED driving board configured to control the operation of the LED circuit board, wherein the LED circuit board is configured to receive signals from the thermosensitive sensor and the photosensitive senor, and to control the light-emitting diode in response to the received signals.

7. The light-emitting diode lamp of claim 1, wherein the lamp shade comprises a toggle switch configured to control the light-emitting diode, and a push button mounted in an aperture of the cover plate of the lamp shade and configured to switch the toggle switch between an ON and an OFF position.

8. The light-emitting diode lamp of claim 7, wherein the toggle switch is configured to operate the thermosensitive sensor, such that, when the toggle switch is in the ON position, both the thermosensitive sensor and the photosensitive sensor are activated, and that, when the toggle switch is in the OFF position, the thermosensitive sensor is deactivated and the photosensitive sensor is activated.
